(19) United States
(12) Patent Application Publication
(10) Pub. No.: US 2014/0167389 A1
(43) Pub. Date: Jun. 19, 2014

(54) GRAIN WAGON HAVING WHEEL WELL COVERS ATTACHED WITH FASTENERS

(71) Applicant: J. & M. MANUFACTURING CO., INC., Ft. Recovery, OH (US)

(72) Inventors: Joshua P. Gaerke, Ft. Recovery, OH (US); James E. Wood, Ft. Recovery, OH (US)

(73) Assignee: J. & M. Manufacturing Co., Inc., Ft. Recovery, OH (US)

(21) Appl. No.: 13/719,787

(22) Filed: Dec. 19, 2012

(51) Int. Cl. B62D 63/08

(52) U.S. Cl. CPC B62D 63/08
USPC 280/400; 280/851

(57) ABSTRACT

A grain cart has a wheel supported frame with a tow hitch, and the frame supports a hopper or container having front and rear walls connected by opposite side walls to define a chamber, and the walls incline downwardly and inwardly to a grain removal zone. Wheel well covers project into the chamber through openings in the inclined walls and have outwardly projecting elongated flanges adjacent the inclined walls. The flanges and the inclined walls have spaced aligned holes which receive fasteners or bolts for attaching the wheel well covers to the walls after components of the grain cart have been shipped to a destination. Each wheel well cover preferably has a generally vertical flat inner wall connected to a curved cover wall, and the flanges project from the inner and cover walls. The wheel well covers are formed to fit over the wheels for shipping efficiency.

### BACKGROUND OF THE INVENTION

This invention relates to grain wagons or carts of the general type disclosed in U.S. Pat. Nos. 7,134,830 and 8,047,757 which issued to the assignee of the present invention and the disclosures of which are herein incorporated by reference. Frequently, it is desirable for such a grain wagon to have wheel well covers projecting inwardly from the inclined side walls of the grain hopper or container for receiving extra wide wheels, as disclosed in above '757 Patent or dual wheels, as disclosed in above '830 Patent, or to avoid the wheels projecting laterally outwardly from the sides of the container in order to minimize the overall width of the cart. The wheel well covers are fabricated from sheet metal as are the walls of the grain container, and the wheel well covers are formed by welding flat and/or curved panels together, and then welding the panels to the inclined walls of the container. The welding operations of the curved wheel well covers to the inclined walls of the grain container requires substantial time to insure that there is no gap or crack through which grain may leak from the container. Also, when a plurality of grain carts are shipped to a distant destination, for example, to a foreign country, the welded-on wheel well covers result in the containers requiring more shipping space on a railroad car or a ship container.

### SUMMARY OF THE INVENTION

The present invention is directed to a wheel supported grain cart having a fabricated sheet metal grain hopper or container and wherein formed wheel well covers are attached to the grain container by a series of fasteners such as bolts and nuts. As a result, a plurality of grain carts may be shipped more efficiently since the containers require less shipping space, and the wheel well covers may be conveniently attached to the containers after the grain carts arrive at their destination. Each of the wheel well covers is constructed with walls having an elongated flange or flanges which project outwardly adjacent portions of the inclined walls of the container. The outwardly projecting flanges on each wheel well cover are subsequently fastened or bolted to the inclined walls of the grain container. In addition, the wheel well covers are constructed so that they may partially cover a stack of the grain cart wheels and thereby add little shipping space for the wheels.

Other features and advantages of the invention will be apparent from the following description, the accompanying drawings and the appended claims.

### BRIEF DESCRIPTION OF THE DRAWINGS

FIG. 1 is a side elevational view of a grain cart having wheel well covers attached to side walls of the cart with fasteners in accordance with the invention;

FIG. 2 is a fragmentary inside perspective view of the grain cart container shown in FIG. 1 and showing an attached wheel well;

FIG. 3 is a perspective view of an attachable wheel well as shown in FIG. 2;

FIG. 4 is a perspective view of a pair of wheel well covers positioned on a stack of wheels for efficient shipping; and

FIG. 5 is a fragmentary section taken generally on the line 5-5 of FIG. 2 and showing the attachment of a wheel well cover to a side wall of the container.

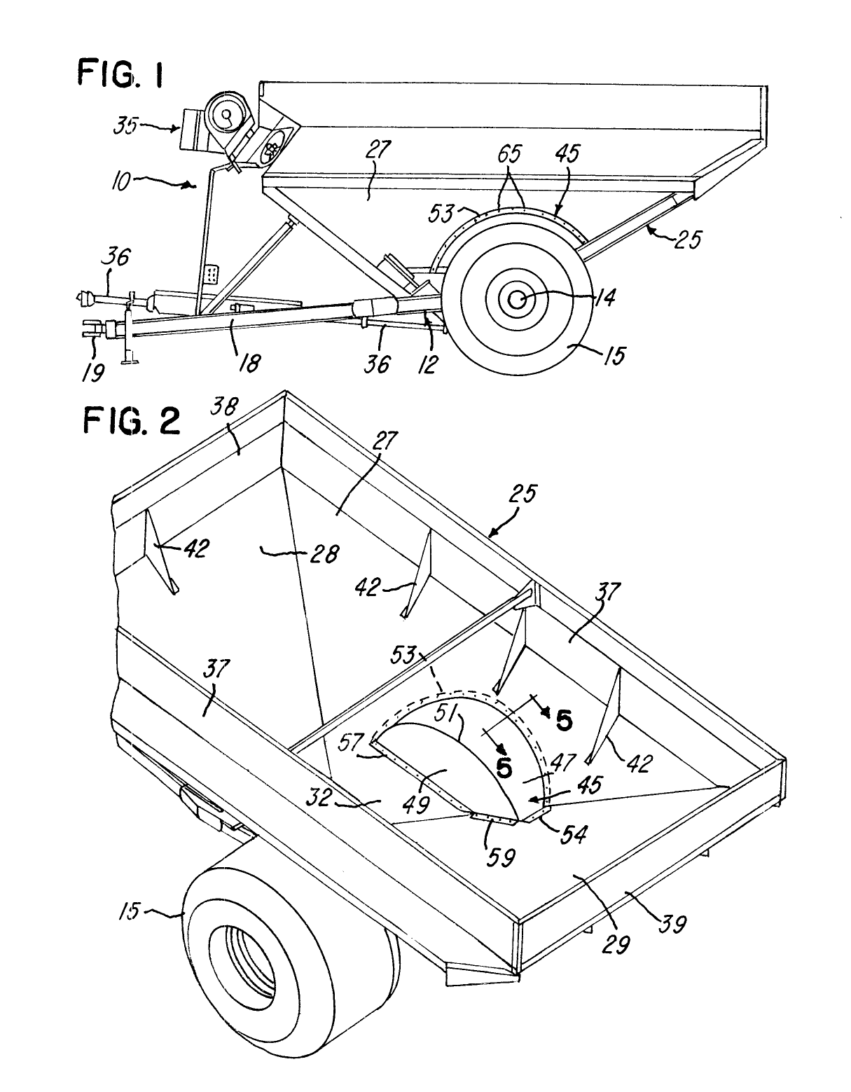

### DESCRIPTION OF THE ILLUSTRATED EMBODIMENT

Referring to FIG. 1, a grain cart 10 is constructed similar to the grain carts disclosed in above-mentioned U.S. Pat. Nos. 7,134,830 and 8,047,757 and has corresponding components. The cart generally includes a fabricated metal frame 12 which is supported by an axle 14 on which is mounted a pair of wheels 15. The frame 12 includes forwardly projecting frame members 18 which connect with a hitch 19 for towing the grain cart behind a tractor or other vehicle.

The frame 12 supports a fabricated sheet metal grain hopper or container 25 which is formed by opposite inclined side walls 27, an inclined front wall 28 and an inclined rear wall 29. All of the walls 27-29 slope downwardly and inwardly to a grain receiving zone 32 where the grain is received by the inlet portion of a folding discharge auger conveyor 35 constructed as disclosed in either the above '830 Patent or '757 Patent. The auger conveyor is commonly driven by a drive shaft 36 connected to the power take off of the tow tractor. The inclined walls 27-29 of the container 25 are also shown with upwardly projecting extension wall panels 37, 38 and 39, respectively, to confine the grain within the container, and the extension wall panels are braced or reinforced by angular sheet metal brackets 42.

In accordance with the present invention, a set or pair of sheet metal wheel well covers 45 are inserted through mating cutouts or openings within the side walls 27 and rear walls 29 of the container 25, and each wheel well cover 45 includes a curved or arcuate cover wall 47 and a generally vertical flat wall 49 which are welded together along the arcuate or curved seam 51. The cover wall 47 has a peripherally extending arcuate flange 53 which projects outwardly and upwardly adjacent the corresponding side wall 27. The cover wall 47 also has a straight rear flange 54 which projects outwardly and upwardly adjacent the rear wall 29 of the container. The vertical wall 49 of each wheel well cover 45 has an outwardly projecting straight or linear flange 57 which extends downwardly adjacent the inclined side wall 27 and also has a straight or linear inclined flange 59 which projects outwardly and upwardly adjacent the inclined rear wall 29. The flanges 53, 54, 57 and 59 may project adjacent the inner surfaces of the inclined walls 27 and 29 or may project adjacent the outer surfaces of the inclined walls 27 and 29, depending upon which is the easiest and fastest method to assemble each wheel well cover 45 onto the inclined side wall 27 and rear wall 29 of the container.

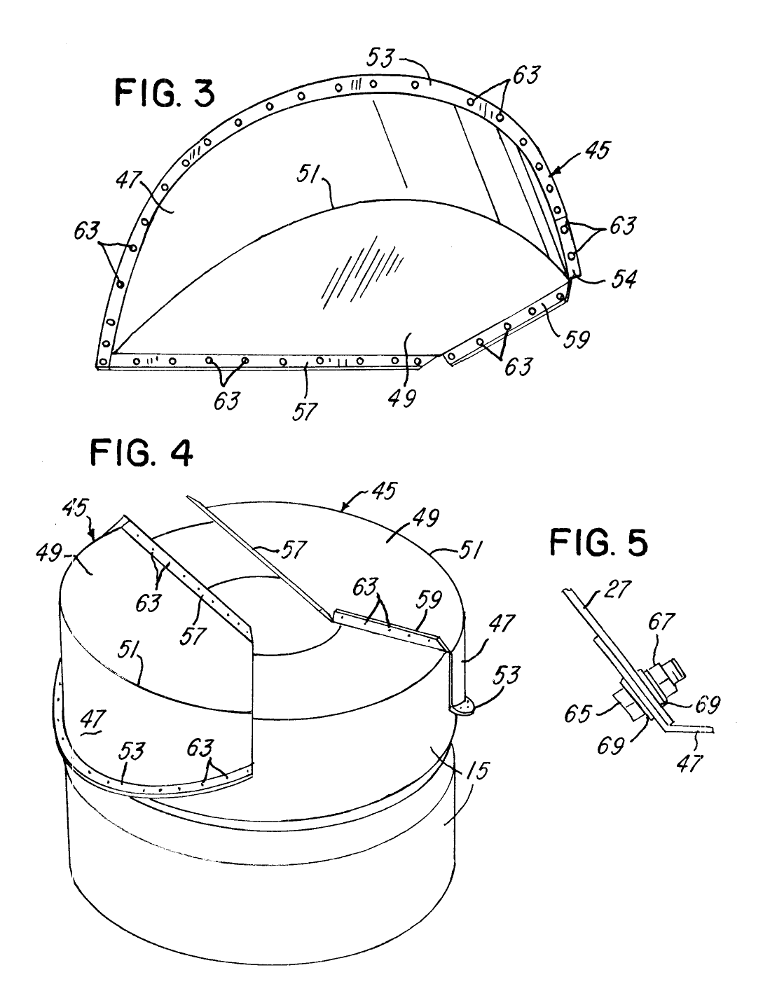

As best shown in FIG. 3, each of the flanges 53, 54, 57 and 59 of each wheel well cover 45 is provided with longitudinally spaced holes 63, and corresponding aligned holes are formed within the side wall 27 and rear wall 29. As shown in FIG. 5, each of the aligned holes within each wheel well cover 45 and the adjacent walls of the container 25 receives a fastener, preferably in the form of a bolt 65 and nut 67. Each bolt 65 may receive a lock and sealing washer 69 to assure a positive grain-tight seal. However, other forms of fasteners may be used, for example, pop rivets. After all of the fasteners or bolts 65 for each wheel well cover 45 are secured, the wheel well covers 45 are attached and sealed to the inclined side walls 27 and rear wall 29 to form a grain-tight chamber within the container 25.

Referring to FIG. 4, when it is desired to ship a plurality of grain carts by rail car or by a container on a ship, a plurality of wheels 15 are stacked, and a set or pair of wheel well covers 45 are mounted on top of the stack of wheels so that the wheel well covers do not require any significant additional space for shipping. The rest of the sheet metal containers 25 may be shipped in nested relation or as flat panels which are later welded together along straight corner seams. The remaining components of the grain carts 10 may be shipped in nested or stacked relation in order to minimize the shipping space required for a plurality of grain carts.

From the drawings and the above description, it is apparent that a grain cart with separate and attachable wheel well covers provides desirable advantages, especially when shipping a plurality of grain carts in railroad cars or containers on ships by minimizing space required on the railroad car or ship container. In addition, each of the sheet metal wheel well covers 45 may be quickly and efficiently attached to the sheet metal walls of the container by the use of power driven tools or wrenches to install the fasteners 65. The wheel well covers 45 may a so be efficiently shipped by locating the covers on a stack of wheels 15.

While the form of grain cart with attachable wheel well covers herein described constitutes a preferred embodiment of the invention, it is to be understood that the invention is not limited to this precise form of the invention, and that changes made therein without departing from the scope and spirit of the invention as defined in the appended claims.

What is claimed is:

1. A grain cart comprising
a frame supported by a set of wheels,
a container supported by said frame and defining a chamber for receiving a volume of grain,
said container including a front wall and a rear wall rigidly connected by opposite inclined side walls sloping downwardly and inwardly towards a grain removal zone,
said container further including a set of opposing wheel well covers projecting horizontally into said chamber from said opposite inclined side walls,
each of said wheel well covers including an inner wall connected to a cover wall overlying one of said wheels,
said cover wall of each of said wheel well covers including an outwardly projecting elongated flange adjacent one of said side walls with said flange having a series of longitudinally spaced holes,
each of said side walls having a series of spaced holes aligned with said series of spaced holes within said flange of said cover wall of one of said wheel well covers, and
a plurality of fasteners extending through said aligned holes and securing said cover wall of each of said wheel well covers to one of said inclined side walls.

2. A grain cart as defined in claim 1 wherein said rear wall of said container is inclined inwardly and downwardly toward said grain removal zone, said cover wall of each of said wheel well covers includes an outwardly projecting elongated rear flange adjacent said rear wall, a series of longitudinal spaced aligned holes within said rear flange of each said cover wall and said inclined rear wall of said container, and a plurality of fasteners within said aligned holes in each said rear flange and said rear wall and cooperating to secure said wheel well covers to said inclined rear wall.

3. A grain cart as defined in claim 1 wherein said inner wall of each of said wheel well covers includes an outwardly projecting elongated inner flange having longitudinally spaced holes aligned with corresponding spaced holes in one of said inclined side walls, and a plurality of fasteners extending through said aligned spaced holes within said inner flange of said inner wall of each of said wheel well covers and said aligned spaced holes within said one of said inclined side walls of said container.

4. A grain cart as defined in claim 1 wherein said cover wall of each of said wheel well covers is curved, and a curved said flange on each said cover wall.

5. A grain cart as defined in claim 1 wherein said inner wall of each of said wheel well covers has an elongated linear flange extending adjacent one of said side walls of said container, and said linear flange and said adjacent one of said side walls has spaced aligned holes receiving said fasteners.

6. A grain cart as defined in claim 1 wherein said cover wall of each of said wheel well covers includes an elongated linear flange adjacent an inclined said rear wall of said container, and said linear flange and said adjacent rear wall have spaced aligned holes receiving said fasteners.

7. A grain cart as defined in claim 1 wherein said wheel well covers conform to one of said wheels and receive said wheel to facilitate shipping said wheels and said wheel well covers and to minimize shipping space for said wheel well covers.

8. A grain cart comprising
a frame supported by a set of wheels,
a container supported by said frame and defining a chamber for receiving a volume of grain,
said container including a front wall and a rear wall rigidly connected by opposite inclined side walls sloping downwardly and inwardly towards a grain removal zone,
said container further including a set of opposing wheel well covers projecting horizontally into said chamber from said opposite inclined side walls,
each of said wheel well covers including an inner wall connected to a cover wall overlying one of said wheels,
said cover wall of each of said wheel well covers including an outwardly projecting elongated flange adjacent one of said side walls with said flange having a series of longitudinally spaced holes,
said inner wall of each of said wheel well covers includes an outwardly projecting elongated inner flange having a series of longitudinally spaced holes and extending adjacent said one of said side walls;
each of said side walls having a series of spaced holes aligned with said series of spaced holes within said flange of said inner wall and said flange of said cover wall of one of said wheel well covers, and
a plurality of fasteners extending through said aligned holes and securing said inner wall and said cover wall of each of said wheel well covers to one of said inclined side walls.

9. A grain cart as defined in claim 8 wherein said cover wall of each of said wheel well covers is curved, and a curved said flange on each said cover wall.

10. A grain cart as defined in claim 8 wherein said cover wall of each of said wheel well covers includes an elongated linear flange adjacent an inclined said rear wall of said container, and said linear flange and said adjacent rear wall have spaced aligned holes receiving said fasteners.

11. A grain cart as defined in claim 8 wherein each of said wheel well covers conforms to one of said wheels and receive said wheel to facilitate shipping said wheels and said wheel well covers and to minimize shipping space for said wheel well covers.
